(19) United States
(12) Patent Application Publication
(10) Pub. No.: US 2026/0133137 A1
(43) Pub. Date: May 14, 2026

(54) SYSTEM AND METHOD FOR DETECTING WAFER DEFECTS USING NONLINEAR OPTICAL SIGNALS

(71) Applicant: SPIROX CORPORATION, Hsinchu City (TW)

(72) Inventors: Yao-Chou Yang, Hsinchu City (TW); Feng-Chieh Li, Hsinchu City (TW); Yen-Cheng Chao, Hsinchu City (TW)

(21) Appl. No.: 19/175,215

(22) Filed: Apr. 10, 2025

(30) Foreign Application Priority Data
Nov. 14, 2024 (TW) 113143874
Dec. 27, 2024 (TW) 113151353

(51) Int. Cl. G01N 21/95; G01N 21/88

(52) U.S. Cl. CPC G01N 21/9501; G01N 21/8806

(57) ABSTRACT

A system and method for detecting wafers using nonlinear optical signals includes a noise reduction module configured to obtain outgoing light from a test sample, wherein the noise reduction module includes a series of beam splitter assemblies and a photodetector assembly for receiving proportional light beams from the beam splitter assemblies, and attenuating a homogeneous area signal of the test sample as well as the background noise randomly generated during the photoelectric conversion process, thereby reducing the overall background noise.

### CROSS REFERENCE TO RELATED APPLICATIONS

This application claims priority of Application No. 113 143 874 filed in Taiwan on Nov. 14, 2024 and Application No. 113 151 353 filed in Taiwan on Dec. 27, 2024 under 35 U.S.C. § 119, the entire contents of all of which are hereby incorporated by reference.

### TECHNICAL FIELD

The present invention relates to a nonlinear optical detection technology, particularly to a nonlinear optical detection system and method for detecting wafer defects.

### BACKGROUND

Wide bandgap (WBG) materials, such as silicon carbide (SiC), have excellent properties such as high breakdown voltage resistance, high frequency, high thermal tolerance, and low power loss, and are therefore widely used in high-power, high-frequency electronic components and other fields. However, microscopic defects inside silicon carbide wafers may cause component performance degradation or even failure, so defect detection technology is crucial.

The following two methods are used for detecting defects in traditional silicon carbide wafers:

Destructive testing: for example, the KOH etching method is capable of detecting crystal defects but damage the wafer, causing material waste.

Non-destructive testing: for example, X-ray diffraction, optical microscopy, and other techniques, but these methods can usually only detect defects on the surface of the wafer and cannot effectively detect crystal defects deep inside the wafer.

Nonlinear optical inspection technology is an emerging, non-destructive, non-contact inspection method. Nonlinear optics is highly sensitive to crystal structures and defects in materials, enabling the detection of microscopic flaws that are difficult to identify with traditional methods, without direct contact with the material and without causing damage to the material.

Prior art CN117491384B, titled “Wafer Inspection System and Inspection Method,” discloses a technology for nonlinear optical detection of crystal defects. The inspection system includes a stage, a light source module, an optical detection module, and a beam splitter. The beam splitter separates the reflected light from the test sample into a first harmonic signal and a second harmonic signal. The optical detection module analyzes the first harmonic signal and the second harmonic signal separately. The surface characteristic parameters of the test sample, such as film thickness, refractive index, and extinction coefficient, are derived from the first harmonic signal. The ‘electrical characteristic data’ of the test sample is derived from the second harmonic signal. By combining the surface characteristic parameters and electrical characteristic data of the test sample, the wafer can be measured more accurately. The “electrical characteristic data” is used to determine whether the electrical performance of the test sample is abnormal by evaluating whether the actual p-polarization and s-polarization component ratios fall within a predetermined reference range.

Nonlinear optical detection can generate two-dimensional or three-dimensional images of internal defects in wafers, visualizing the distribution and morphology of the defects. However, a low image signal-to-noise ratio is one of the technical bottlenecks of nonlinear optical detection. The main reasons for the low image signal-to-noise ratio include noise generated in the homogeneous regions of the test sample and randomly generated background noise produced by the photodetector during the photoelectric conversion process. These noises cause the second harmonic signals that represent the defective areas of the wafer to become less clear, thereby reducing the signal-to-noise ratio and affecting the accuracy of the final measurement or detection.

Prior art TW202405409A, titled “Shot Noise Reduction Using Frame Averaging” uses an image processing algorithm to suppress noise in an image and to further identify defects. Illuminating a sample (an unpatterned wafer) with a light source, with the light source potentially including any laser system, enables the acquisition of multiple images of the sample. The acquired images of the sample are categorized into detection images and reference images. The acquired images of the sample are repeatedly captured from the same area of the sample, including both a detection area and a reference area. Multiple images are averaged to generate an averaged image of the region. Averaging is achieved by adding the intensity values at each corresponding pixel location and then dividing by the number of images. Alternatively, a reference image can be subtracted from the average inspection image to generate a difference image, and the difference image can be analyzed to detect defects in the sample's inspection area.

### SUMMARY OF THE INVENTION

Problems to be solved by the present invention:

To enhance the signal-to-noise ratio (SNR) of an image, not through image processing algorithms, but by utilizing a noise reduction module to suppress noise from the homogeneous area of the test sample as well as background noise generated during a photoelectric conversion process.

Technical features of the present invention:

A system and method for detecting wafer defects using nonlinear optical signals, comprising: using a noise reduction module to obtain outgoing light from a designated area of a test sample at the same position and at the same time, wherein the noise reduction module is composed of a beam splitter assembly and a photodetector assembly for receiving proportional light beams from the beam splitter assembly; and attenuating a homogeneous area signal of the designated area, as well as the background noise randomly generated by the photoelectric assembly during the photoelectric conversion process, thereby reducing the overall background noise to highlight the frequency-doubled signal retained and improve a signal-to-noise ratio.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a first embodiment of the noise reduction module of the present invention.

FIG. 2 is a second embodiment of the noise reduction module of the present invention.

FIG. 3 is a third embodiment of the noise reduction module of the present invention.

FIG. 4 is a fourth embodiment of the noise reduction module of the present invention.

FIG. 5 is a fifth embodiment of the noise reduction module of the present invention.

FIG. 6 is a sixth embodiment of the noise reduction module of the present invention.

FIG. 7 is a seventh embodiment of the noise reduction module of the present invention.

FIG. 8 is an eighth embodiment of the noise reduction module of the present invention.

FIG. 9 is a ninth embodiment of the noise reduction module of the present invention.

FIG. 10 is an image of a test sample in according with the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

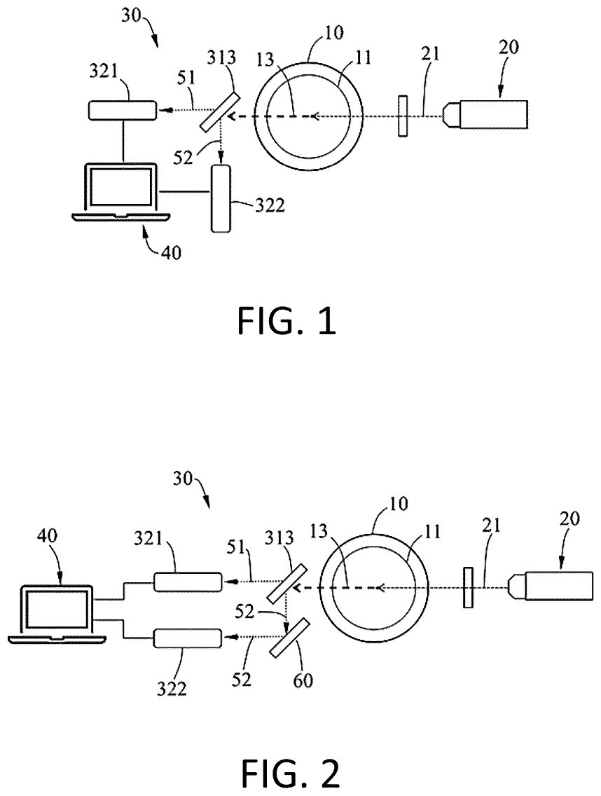

Referring to FIGS. 1 to 9, in a first aspect, the present invention provides a system for detecting wafer defects using nonlinear optical signals includes:

A stage 10 configured to carry a test sample 11. The test sample 11 is a test wafer, in particular, a silicon carbide wafer. The stage 10 may include a mirror reflection structure facing the test sample 11.

A light source module 20 generates fundamental frequency light 21 and guides the light to the test sample 11, producing outgoing light 13 from the test sample 11. The light source module 20 is configured to generate fundamental frequency light 21 of a specific wavelength, and the light source includes, but is not limited to, a pulse laser with an output power of 100-200 mW and a repetition rate of 30-80 MHz. The fundamental frequency light 21 emitted by the light source module 20 passes through a series of optical elements, including, but not limited to, lenses, reflector mirrors, and magnifying objective lenses, for focusing and/or amplification, ensuring that the fundamental frequency light 21 accurately irradiates a designated area on the test sample 11, thereby generating outgoing light 13 containing a frequency-doubled signal from the designated area. Wherein the frequency-doubled signal is a second harmonic signal generated by second harmonic generation (SHG).

A noise reduction module 30 receives outgoing light 13 from the same position and at the same time of the designated area on the test sample 11. The core components of the noise reduction module 30 include a series of beam splitter assembly and a photodetector assembly that receives a split light beam from the beam splitter assembly. The photodetector assembly includes several photomultiplier tubes (PMTs). A photomultiplier tube (PMT) is a device capable of converting weak light signal into measurable electric current and significantly amplifying the weak light signal. In the present invention, other devices capable of converting optical signals into an electrical signal and amplifying the optical signal may also replace the photomultiplier tube (PMT), including but not limited to photodiode (PD), an avalanche photodiode (APD), and a charge-coupled device (CCD). The noise reduction module 30 is used to reduce the homogeneous area signal of the test sample 11 and enhance the defect area signal. The noise reduction module 30 includes several implementation aspects, as detailed below. In a preferred embodiment, the photodetector assembly includes several photodetectors. Each photodetector can individually adjust the output gain of the photodetector to improve the amplification capability for incident light signals. Different types of photodetectors, such as a photomultiplier tube (PMT) or photodiode (PD), have different methods for adjusting gain. For example, the gain of the photomultiplier tube (PMT) is mainly determined by the voltage applied between the photocathode and the multiplication stages (dynodes). Increasing high voltage enhances the electric field strength between the multiplication stages, resulting in higher electron energies at each multiplication stage, leading to an increase in the final output gain. Typically, the gain and voltage of photomultiplier tube (PMT) are exponentially related: GoVn, where G is gain, V is applied voltage, and n is an exponent related to the number of multiplication stages (usually between 5 and 8). The PMT is usually equipped with high voltage power supply module. Voltage can be adjusted by a high voltage power supply module via a manual knob, digital input settings, or through computer programs.

A signal processing and imaging module 40 is coupled to the noise reduction module 30 to acquire and process the electrical signals from the noise reduction module 30 and generate images of defect areas of the test sample 11. The signal processing and imaging module 40 may use or may not use known image processing techniques, including but not limited to color blending, grayscale enhancement, and grayscale sharpening multiplication to further enhance the frequency-doubled image.

An embodiment of the noise reduction module 30 is as follows.

FIG. 1 shows the first embodiment.

The beam splitter assembly comprises a beam splitter, and the photodetector assembly comprises two photodetectors;

The beam splitter is defined as a first beam splitter 313. The first beam splitter 313 is disposed in the optical path of the outgoing light 13 of the test sample 11. The beam splitter has a beam-splitting ratio of 50:50, with an allowable error of +5%. The outgoing light 13 of the test sample 11 is divided into a first light beam 51 and a second light beam 52, wherein the first light beam 51 has a 50% light proportion and the second light beam 52 has a 50% light proportion. The first light beam 51 is received by the first photodetector 321, and the second light beam 52 is received by the second photodetector 322.

FIG. 2 shows the second embodiment.

The beam splitter assembly comprises a beam splitter, and the photodetector assembly comprises two photodetectors. Additionally, a reflector mirror 60 is further provided.

The beam splitter is disposed in the optical path of the outgoing light 13. The beam splitter has a beam-splitting ratio of 50:50, dividing the outgoing light 13 of the test sample 11 into a first light beam 51 and a second light beam 52, wherein the first light beam 51 is received by the first photodetector 321. The reflecting mirror 60 is arranged in the optical path of the second light beam 52, focusing and reflecting the second light beam 52 to be received by the second photodetector 322.

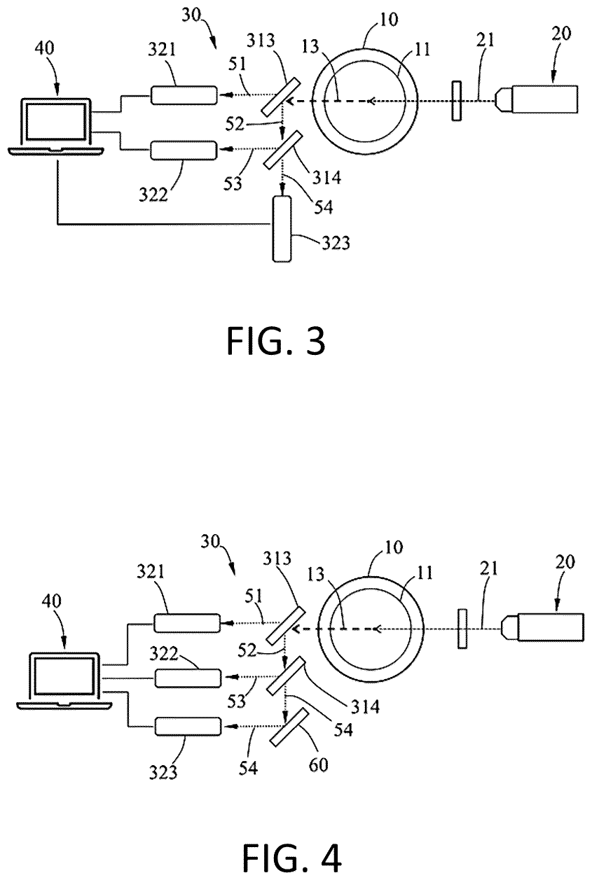

FIG. 3 shows the third embodiment.

The beam splitter assembly comprises two beam splitters, and the photodetector assembly comprises three photodetectors.

The two beam splitters are defined as the first beam splitter 313 and a second beam splitter 314. The beam splitter can be a general beam splitter or a polarizing beam splitter. The three photodetectors are defined the first photodetector 321, the second photodetector 322, and a third photodetector 323.

The first beam splitter 313 is disposed in the optical path of the outgoing light 13 of a test sample 11. The first beam splitter has a beam-splitting ratio of 30:70 with an allowable error of +5%, dividing the outgoing light 13 into a first light beam 51 and a second light beam 52. The first light beam 51 has a 30% light proportion, and the second light beam 52 has a 70% light proportion. The first light beam 51 is received by the first photodetector 321.

The second beam splitter 314 is disposed in the optical path of the second light beam 52, the second beam splitter 314 has a beam-splitting ratio of 50:50, with an allowable error of +5%. The second light beam 52 (70% light proportion) is further divided into a third light beam 53 and a fourth light beam 54. Therefore, the third light beam 53 is 35% light proportion, and the fourth light beam 54 also has a 35% light proportion. The third light beam 53 is received by the second photodetector 322, the fourth light beam 54 is received by the third photodetector 323.

FIG. 4 shows the fourth embodiment.

The beam splitter assembly comprises two beam splitters, and the photodetector assembly comprises three photodetectors. Additionally, a reflector mirror 60 is further provided.

The two beam splitters are defined as the first beam splitter 313 and a second beam splitter 314. The beam splitter can be a general beam splitter or a polarizing beam splitter. The three photodetectors are defined the first photodetector 321, the second photodetector 322, and a third photodetector 323.

The first beam splitter 313 is disposed in the optical path of the outgoing light 13 of a test sample 11. The first beam splitter has a beam-splitting ratio of 30:70 with an allowable error of +5%, dividing the outgoing light 13 into a first light beam 51 and a second light beam 52. The first light beam 51 has a 30% light proportion, and the second light beam 52 has a 70% light proportion. The first light beam 51 is received by the first photodetector 321.

The second beam splitter 314 is disposed in the optical path of the second light beam 52, the second beam splitter 314 has a beam-splitting ratio of 50:50, with an allowable error of +5%. The second light beam 52 (70% light proportion) is further divided into a third light beam 53 and a fourth light beam 54. Therefore, the third light beam 53 is 35% light proportion, and the fourth light beam 54 also has a 35% light proportion. The third light beam 53 is received by the second photodetector 322. The reflecting mirror 60 is arranged in the optical path of the fourth light beam 54, focusing and reflecting the third light beam 53 to be received by the third photodetector 323.

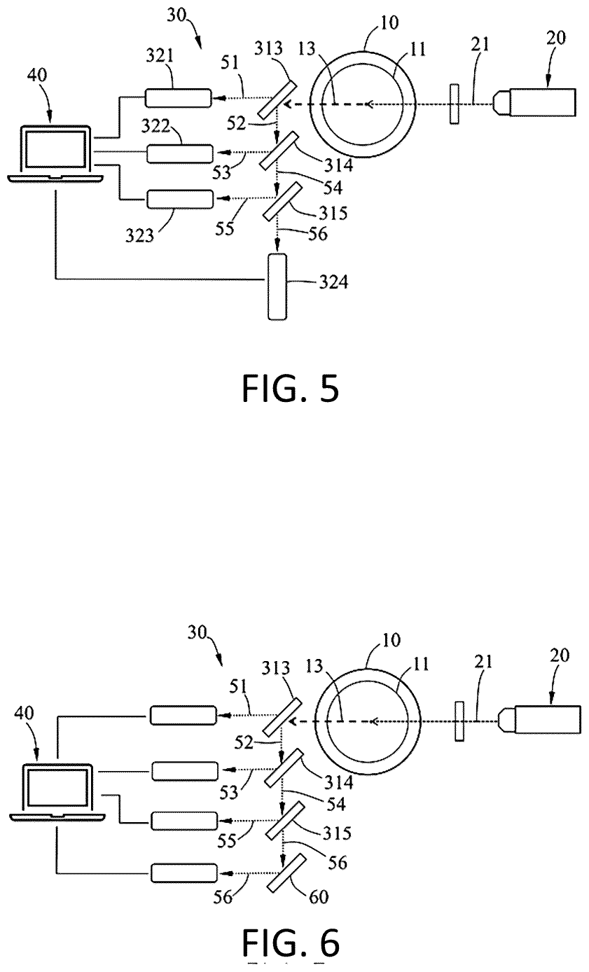

FIG. 5 shows the fifth embodiment.

The beam splitter assembly comprises three beam splitters, and the photodetector assembly comprises four photodetectors.

The three beam splitters are defined as the first beam splitter 313, the second beam splitter 314 and a third beam splitter 315. The beam splitter can be a general beam splitter or a polarizing beam splitter. The four photodetectors are defined the first photodetector 321, the second photodetector 322, the third photodetector 323, and a fourth photodetector 324.

The first beam splitter 313 is disposed in the optical path of the outgoing light 13 of a test sample 11. The first beam splitter has a beam-splitting ratio of 20:80 with an allowable error of ±5%, dividing the outgoing light 13 into a first light beam 51 and a second light beam 52. The first light beam 51 has a 20% light proportion, and the second light beam 52 has a 80% light proportion. The first light beam 51 is received by the first photodetector 321.

The second beam splitter 314 is disposed in the optical path of the second light beam 52, the second beam splitter 314 has a beam-splitting ratio of 30:70, with an allowable error of ±5%. The second light beam 52 (80% light proportion) is further divided into a third light beam 53 and a fourth light beam 54. Therefore, the third light beam 53 is 24% light proportion, and the fourth light beam 54 also has a 56% light proportion. The third light beam 53 is received by the second photodetector 322.

The third beam splitter 315 is disposed in the optical path of the fourth light beam 54, the third beam splitter 315 has a beam-splitting ratio of 50:50, with an allowable error of ±5%. The fourth light beam 54 (56% light proportion) is further divided into a fifth light beam 55 and a sixth light beam 56. Therefore, the fifth light beam 55 is 28% light proportion, and the sixth light beam 56 also has a 28% light proportion. The fifth light beam 55 is received by the third photodetector 323, the sixth light beam 56 is received by the fourth photodetector 323.

FIG. 6 shows the sixth embodiment.

The beam splitter assembly comprises three beam splitters, and the photodetector assembly comprises four photodetectors. Additionally, a reflector mirror 60 is further provided.

The three beam splitters are defined as the first beam splitter 313, the second beam splitter 314 and a third beam splitter 315. The beam splitter can be a general beam splitter or a polarizing beam splitter. The four photodetectors are defined the first photodetector 321, the second photodetector 322, the third photodetector 323, and a fourth photodetector 324.

The first beam splitter 313 is disposed in the optical path of the outgoing light 13 of a test sample 11. The first beam splitter has a beam-splitting ratio of 20:80 with an allowable error of ±5%, dividing the outgoing light 13 into a first light beam 51 and a second light beam 52. The first light beam 51 has a 20% light proportion, and the second light beam 52 has a 80% light proportion. The first light beam 51 is received by the first photodetector 321.

The second beam splitter 314 is disposed in the optical path of the second light beam 52, the second beam splitter 314 has a beam-splitting ratio of 30:70, with an allowable error of ±5%. The second light beam 52 (80% light proportion) is further divided into a third light beam 53 and a fourth light beam 54. Therefore, the third light beam 53 is 24% light proportion, and the fourth light beam 54 also has a 56% light proportion. The third light beam 53 is received by the second photodetector 322.

The third beam splitter 315 is disposed in the optical path of the fourth light beam 54, the third beam splitter 315 has a beam-splitting ratio of 50:50, with an allowable error of ±5%. The fourth light beam 54 (56% light proportion) is further divided into a fifth light beam 55 and a sixth light beam 56. Therefore, the fifth light beam 55 is 28% light proportion, and the sixth light beam 56 also has a 28% light proportion. The fifth light beam 55 is received by the third photodetector 323. The reflecting mirror 60 is arranged in the optical path of the sixth light beam 56, focusing and reflecting the sixth light beam 56 to be received by the fourth photodetector 323.

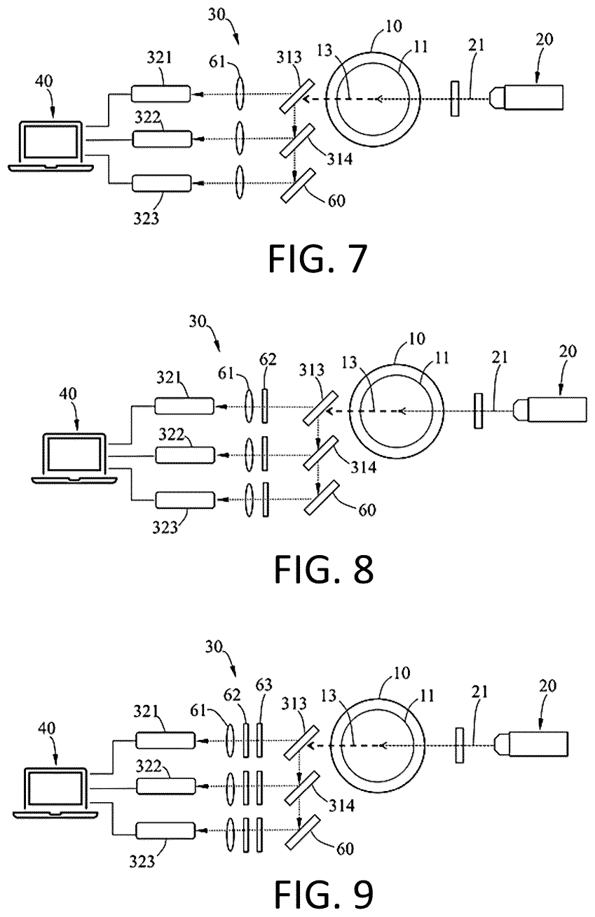

FIGS. 7, 8, and 9 show the seventh, eighth, and ninth embodiments.

At least one of a lens 61, a neutral density filter 62, and a polarization element 63, or any combination thereof, is selectively arranged on the optical path before the photodetector assembly.

Based on the above embodiments, the implementation of the noise reduction module 30 follows the following principles:
1. Two or more photodetectors are arranged side by side.
2. A beam splitter is used to distribute the light beam to the photodetectors in appropriate proportions.
3. The beam splitter is configured of that the difference in light intensity received by each photodetector is within 10%.
4. The gain value of each channel's photodetector is adjusted so that the difference in output signal intensity among the channels is within 10%.
5. Each channel simultaneously acquires the light intensity signal of the test sample 11 at the same position and time.

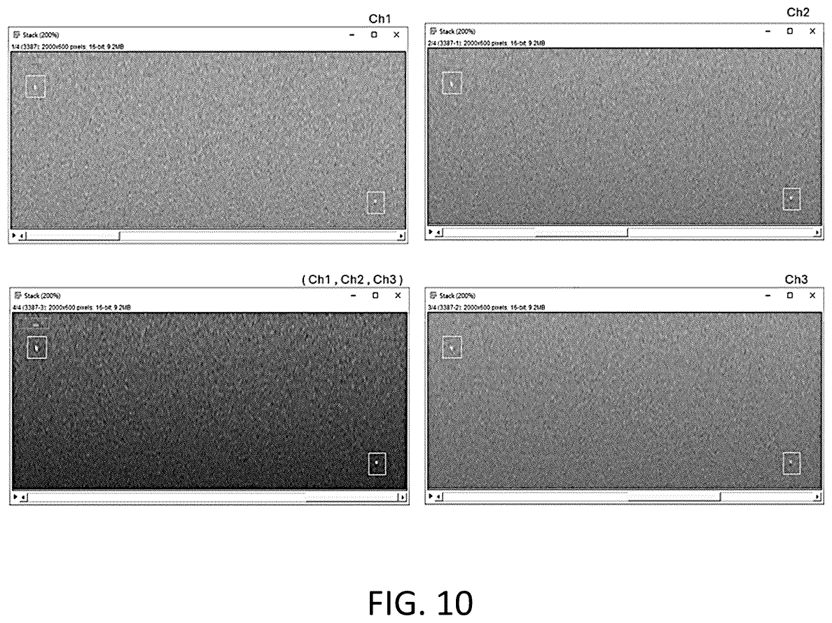

The present invention utilizes a noise reduction module composed of multiple beam splitters and photodetectors to obtain outgoing light from a designated area of a test sample at the same position and the same time; and attenuating a homogeneous area signal of the designated area and background noise randomly generated during a photoelectric conversion process through the noise reduction module, thereby reducing overall background noise to highlight the frequency-doubled signal retained and improve a signal-to-noise ratio (SNR). Please refer to FIG. 10 for related images. The bright spots marked by boxes in the image are wafer defects represented by frequency-doubled light, and there is almost no noise in the background of the image.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A system for detecting wafer defects using nonlinear optical signals, comprising:
a light source module configured to emit fundamental frequency light of a specific wavelength, wherein the fundamental frequency light is directed onto a designated area of a test sample, generating outgoing light from the designated area;
a noise reduction module includes a least one beam splitter assembly and a photodetector assembly configured to receive proportional light beam from the beam splitter; the photodetector assembly converts the optical signal into an electrical signal and amplifies the electrical signal; the noise reduction module receives the outgoing light from the same position and at the same time of the designated area and attenuates a homogeneous area signal of the designated area, as well as the background noise randomly generated by the photodetector assembly during the photoelectric conversion process, thereby reducing the overall background noise to highlight the frequency-doubled signal retained and improve a signal-to-noise ratio; and
a signal processing and imaging module is coupled with the noise reduction module to acquire process an electrical signal from the noise reduction module and generate a frequency-doubled image of the test sample.

2. The system for detecting wafer defects using nonlinear optical signals according to claim 1, wherein the photodetector assembly comprises a plurality of photodetectors, and the plurality of photodetectors can adjust the output gain.

3. The system for detecting wafer defects using nonlinear optical signals according to claim 1, wherein the frequency-doubled signal is a second harmonic signal generated by second harmonic generation (SHG).

4. The system for detecting wafer defects using nonlinear optical signals according to claim 1, wherein the photodetector comprises any one or a combination of a photodiode (PD), an avalanche photodiode (APD), a charge-coupled device (CCD), and a photomultiplier tube (PMT).

5. The system for detecting wafer defects using nonlinear optical signals according to claim 1, wherein the beam splitter assembly comprises a first beam splitter, the photodetector assembly comprises a first photodetector and a second photodetector, and
wherein the first beam splitter splits the outgoing light into a first beam and a second beam, wherein the first beam is received by the first photodetector, and the second beam is received by the second photodetector.

6. The system for detecting wafer defects using nonlinear optical signals according to claim 5, wherein the first beam splitter is configured with a beam-splitting ratio of 50:50 with an allowable error of ±5%.

7. The system for detecting wafer defects using nonlinear optical signals according to claim 1, wherein the beam splitter assembly comprises the first beam splitter and a second beam splitter, the photodetector assembly comprises the first photodetector, the second photodetector, and a third photodetector,
wherein the first beam splitter is configured to split the outgoing light into a first beam and a second beam, wherein the second beam is configured with a higher splitting ratio than the first beam, and the first beam is received by the first photodetector, and
wherein the second beam splitter is disposed in the optical path of the second beam to further split the second beam into a third beam and a fourth beam, wherein the third beam is received by the second photodetector and the fourth beam is received by the third photodetector.

8. The system for detecting wafer defects using nonlinear optical signals according to claim 7, wherein the first beam splitter is configured with the beam-splitting ratio of 30:70 with an allowable error of ±5%, and the second beam splitter is configured with a beam-splitting ratio of 50:50 with an allowable error of ±5%.

9. The system for detecting wafer defects using nonlinear optical signals according to claim 1, wherein the beam splitter assembly comprises the first beam splitter, the second beam splitter and a third beam splitter; the photodetector assembly comprises the first photodetector, the second photodetector, the third photodetector and a fourth photodetector,
wherein the first beam splitter is configured to split the outgoing light into a first beam and a second beam, wherein the first beam is received by the first photodetector, and the second beam has a higher splitting ratio than the first beam,
wherein the second beam splitter is disposed in the optical path of the second beam to further split the second beam into a third beam and a fourth beam, wherein the third beam is received by the second photodetector, and the fourth beam has a higher splitting ratio than the third beam, and
wherein the third beam splitter is disposed in the optical path of the fourth beam to further split the fourth beam into a fifth beam and a sixth beam, wherein the fifth beam is received by the third photodetector, and the sixth beam is received by the fourth photodetector.

10. The system for detecting wafer defects using nonlinear optical signals according to claim 9, wherein the first beam splitter is configured with a beam-splitting ratio of 20:80 with an allowable error of ±5%, and the second beam splitter has a beam-splitting ratio of 30:70 with an allowable error of ±5%, and the third beam splitter is configured with a beam-splitting ratio of 30:70 with an allowable error of ±5%.

11. The system for detecting wafer defects using nonlinear optical signals according to claim 1, wherein at least one of a lens, a neutral density filter, and a polarization element, or a combination thereof, is disposed on the optical path before the photodetector assembly.

12. A method for detecting wafer defects using nonlinear optical signals, comprising:
using a noise reduction module including a beam splitter assembly and a photodetector assembly to obtain outgoing light from the same position at the same time of a designated area of a test sample; and
attenuating a homogeneous area signal of the designated area and background noise randomly generated during a photoelectric conversion process by the noise reduction module, thereby reducing overall background noise to enhance detection of a frequency-doubled signal and improve a signal-to-noise ratio.
